(19) United States
(12) Patent Application Publication
(10) Pub. No.: US 2008/0185793 A1
(43) Pub. Date: Aug. 7, 2008

(54) Tool Holder

(75) Inventors: Franz Haimer, Hollenbach-Igenhausen (DE); Bernhard Regau, Unterwittelsbach (DE)

Correspondence Address: EDWARDS ANGELL PALMER & DODGE LLP, P.O. BOX 55874, BOSTON, MA, 02205, US

(73) Assignee: Franz Haimer Maschinenbau KG, Hollenbach-Igenhausen (DE)

(21) Appl. No.: 11/885,735

(22) PCT Filed: Mar. 22, 2006
(86) PCT No.: PCT/EP2006/002637

§ 371 Date: Sep. 5, 2007

(30) Foreign Application Priority Data
Mar. 23, 2005 (DE) 10 2005 013 483.1

(51) Int. Cl. B23B 31/02; B23B 27/10; B23B 31/30

(52) U.S. Cl. 279/2.06; 408/56; 408/239 R; 279/4.07

(57) ABSTRACT

The aim of the invention is to improve the guiding of a lubricant through a tool holder in a small quantity lubrication system. According to the invention, a tool holder (1) comprises, in the maintaining body thereof (3), an axially displaceable stop sleeve (45) which is mounted in a through opening (31) which is connected to the receiving opening (13) for a tool shaft (15) and a stop surface (47) which is adjacent to the front end (23) of the tool shaft (15). Said stop sleeve (45) is screwed into an inner thread (43) of the through opening (31) and is coupled in a rotationally fixed manner, but in an axially displaceable manner, to a control tube (49) which engages in said stop sleeve (45) in an axial manner. Said control tube (49) is mounted in an axially fixed manner to the side thereof, but in a rotatable manner to the fluid coupling (27). A lubricant can be guided over the blades of the tool (9) by means of the fluid coupling (27), the control tube (49), the stop sleeve (45) and channels (17). Said tool holder (1) enables the fluid to be guided in an essentially calm manner to the tool, even in small amounts, and simplifies the longitudinal pre-adjustment of the tool unit/tool holder unit.

The invention relates to a tool holder, and in particular a tool holder for a tool which is to be driven so as to rotate about an axis of rotation and the shank of which comprises at least one channel extending along the axis of rotation for a cooling or/and lubricating fluid or defines the channel cross section thereof together with the tool holder.

It is known to introduce coolant or lubricant which is to be supplied in the form of a liquid jet or as mist to the cutting edges of a metal-cutting rotating tool, for example a drill or a milling cutter, from the drive spindle of the machine tool into a central channel of the tool holder and to supply it from here via one or a one or a plurality of axial bore(s) of the tool to the tool cutting edges (DE 103 12 743 A1). It is also known to provide axial grooves for the cooling or lubricating fluid to flow through at the inner circumference of the receiving opening, which receives the tool shank in a press fit, of the tool holder (EP 0 662 223 A1).

In order to manage with the smallest possible quantities of lubricant, minimum quantity lubricating systems (MQL systems) are used in which the lubricant is supplied to the tool cutting edges as mist which is carried by an air stream. There are one-channel MQL systems in which the lubricant mist is produced outside of the tool holder and two-channel systems in which air and lubricant are supplied separately to the tool holder and the lubricant is only atomised in the tool holder. One-channel systems require sufficiently large cross sections of flow in order to enable a sufficient volume flow of misty lubricating fluid to be supplied to the tool cutting edges. However in the case of two-channel systems the cross sections of flow should not be too large, as otherwise insufficiently high flow velocities of the lubricating fluid are attained. The possibility of using the tool holder with both types of system is desirable.

MQL systems react sensitively to air turbulence in the flow path of the lubricating fluid, as can occur at sudden changes in the cross section of flow, for example at edges or corners or in the case of tight deflections of the direction of flow. Air turbulence occurs and the lubricating fluid carried as mist in the air stream precipitates. The channels of the tool holder may become clogged and the lubricant may cake at elevated operating temperatures, as may occur in particular in the case of shrink chucks or similar. However a particular disadvantage lies in the possibility of intermittent lubrication and failure to achieve continuity of the MQL volume flow as a prerequisite for stable and reliable machining.

The overall length of the unit consisting of the tool holder and the tool which is clamped therein is usually measured and adjusted by means of a length adjusting appliance. In the case of a hydraulic expansion chuck or a thermal shrink chuck the tool which is inserted in the receiving opening, which has an expanded diameter, of the tool holder is brought by means of a stop into a predetermined axial position relative to a reference face of the tool holder before the tool holder is tightened. Adjusting appliances of this kind are described, for example, in DE 103 12 743 A1, DE 103 17 576 A1, DE 103 17 574 A1 or DE 202 03 783 U1. In some cases the adjusting appliances require a channel which is coaxial with the axis of rotation and reaches from the side of the coupling section into the shank receiving opening of the tool holder for a stop mandrel which forms a stop for the front end of the tool shank at its free end and establishes the desired position of the tool relative to the tool holder. Conventional tool holders for MQL systems, as are known, for example, from DE 103 12 743 A1, use sleeve screws in order to connect the central lubricating fluid channel of the tool holder to the channels which are provided in the tool. However problems may occur in the handling of the sleeve screw of the known tool holder, in particular if an aim is to automate the tool change.

From a first viewpoint an object of the invention is to provide a tool holder for a tool which is to be driven so as to rotate about an axis of rotation which can be operated in conjunction with a minimum quantity lubricating system and in this respect on the one hand provides sufficiently continuous lubrication and on the other is easy to handle. The tool holder should in particular also enable a simple length pre-adjustment to be carried out.

From the first viewpoint the invention is based on a tool holder for a tool which can be driven so as to rotate about an axis of rotation and the shank of which comprises at least one channel extending along the axis of rotation for a cooling or/and lubricating fluid or defines the channel cross section thereof together with the tool holder, comprising:
A holder body which has a tool receiving section with a receiving opening, which is central relative to the axis of rotation, for receiving the tool shank in a rotationally rigid, yet axially releasable manner, a coupling section for the rotationally rigid, yet releasable connection with a drive spindle driven so as to rotate and a through-opening which is equiaxial with the receiving opening, passes into this and is open towards the side of the coupling section,
a stop sleeve which is disposed so as to be axially mobile in the through-opening and forms a stop face for the front end of the tool shank on the side of the receiving opening and
a fluid coupling, which is central relative to the axis of rotation, on the side of the coupling section for supplying the cooling or/and lubricating fluid.

The object illustrated above is solved according to the invention in that the stop sleeve has an external thread and is seated in an axially screwable manner in an internal thread of the through-opening, that a substantially closed-wall positioning tube, which is axially accessible from the side of the coupling section in the fluid coupling and is coaxial with the axis of rotation, is disposed in the through-opening so as to be rotatable, yet axially fixed relative to the holder body, and that the stop sleeve is coupled in a rotationally rigid, yet axially mobile manner to the positioning tube and axially overlaps in a telescopic manner with the end of the positioning tube which faces the receiving opening.

The stop sleeve and the positioning tube are telescopic relative to one another. As the positioning tube is axially fixed relative to the tool holder, engagement areas of the positioning tube which are intended for the engagement of a positioning tool have an axial position relative to the tool holder which is always invariable, irrespective of the axial position of the stop sleeve. This facilitates handling and in particular permits automation, as the positioning tool of the automatic tool changer meets with the engagement area of the positioning tube in an invariable position relative to the coupling section.

Adjusting appliances which establish the tool position relative to the tool holder by means of a stop mandrel which is introduced from the side of the coupling section can at the same time use the mobile stop mandrel for the rotary drive of the positioning tube.

The stop of the stop sleeve may form a sealing seat for a fluid-tight connection between the stop sleeve and the coolant or lubricant channels, especially when the channels are comprised in the tool shank.

However, depending on the type of channels formed in the tool shank or the receiving opening of the tool receiving section of the tool holder, the stop face of the stop sleeve can also be utilised just as a positioning stop for the length pre-adjustment of the tool-tool holder unit, in particular when grooves are provided at the inner circumference in the receiving opening of the tool receiving section to form the coolant or lubricant channels.

The positioning tube preferably engages in the stop sleeve. This prevents annular gaps which are open towards the direction of flow, thus reducing the risk of lubricant being deposited.

The fluid coupling may comprise a coupling sleeve which projects from the holder body equiaxially with the through-opening towards the side of the coupling section, to which sleeve the positioning tube is axially fixed. As the free end of the coupling sleeve can generally be deflected slightly in a radially resilient manner, yet is axially fixed, the radial compensating movement can thus also be directly transmitted to the positioning tube. In this respect the positioning tube preferably has, in the region of its end which is remote from the stop sleeve, an annular collar which is axially fixed in a rotatable manner in the coupling sleeve. The annular gap which is necessary between the positioning tube and the coupling sleeve for tolerance reasons is thus already largely closed upstream, so that the formation of pockets is prevented.

The coupling sleeve is coupled to a supply line of the main spindle during operation. The positioning tube which is disposed in the coupling sleeve ends in the region of the free end of the coupling sleeve. In order to provide a transition from the supply line of the main spindle into the positioning tube which is as free from turbulence as possible, the positioning tube expediently ends at an axial distance from the free end of the coupling sleeve, therefore forming a slightly stepped transition, or the inner circumference of the positioning tube widens in an approximately frustoconical manner towards the free end of the coupling sleeve.

The tool application area of the positioning tube is preferably an insertion opening with an inner polygonal cross-sectional area, for example a hexagonal area. The inside of the stop sleeve and the outside of the positioning tube may also have positive-locking areas, in particular polygonal cross-sectional areas, which are associated with one another, for the rotationally rigid, yet axially mobile coupling of the stop sleeve to the positioning tube. A configuration of this kind can be implemented in a particularly simple manner if the positioning tube has a tube wall with a polygonal cross section, in particular a hexagonal cross section, substantially over its entire length.

In order to reduce the tendency to turbulence of the fluid flow at the transition from the stop sleeve to the tool shank, the stop sleeve expediently forms a cone which widens towards the receiving opening on the side of the receiving opening.

In order to facilitate handling, although in particular to enable to a tight connection to be achieved between the front end of the tool shank and the stop sleeve with the lowest possible torque, in one preferred configuration the stop sleeve is split in the axial direction, wherein a first sleeve part has the external thread and is connected in a rotationally rigid, yet axially mobile manner to the positioning tube and a second sleeve part forms the stop face and is axially supported equiaxially and in a rotatable manner at the first sleeve part. The torque which is to be applied when the stop sleeve is applied to the front end of the tool shank can thus be significantly reduced, in particular when the second sleeve part is mounted at the first sleeve part via rolling bodies, such as, for example, balls, or sliding contact bearing elements like a pivot bearing. The second sleeve part is expediently guided in a rotationally rigid, yet axially mobile manner at the holder body.

As has already been explained, it should be possible to adjust the tool holder to a predetermined length by means of a length adjusting appliance. The fluid coupling, the positioning tube and the stop sleeve therefore expediently form a receiving channel, which is continuous from the side of the coupling section to the receiving opening and is coaxial with the axis of rotation, for a stop mandrel, which can be adjusted in an axially mobile manner, of the tool length adjusting appliance. The axially adjustable stop mandrel of the adjusting appliance at the same time expediently also forms the positioning tool, which can be coupled in a rotationally rigid manner to the positioning tube, and therefore has complementary application areas which can be displaced along the tool application areas of the positioning tube and which enable the positioning tube to rotate in a selectable axial position of the stop mandrel.

The tool holder illustrated above from the first viewpoint of the invention is primarily intended for tool length adjusting appliances which establish the depth of insertion of the tool shank by means of a stop mandrel which is inserted from the side of the coupling section of the tool holder. Adjusting appliances of this kind are described, for example, in DE 103 17 576 A1 or DE 103 17 574 A1. However it is also conceivable to adjust the length of the tool-tool holder unit to a predetermined value by pushing the tool, optionally manually, which is already displaceably guided in the receiving opening of the tool holder, by way of its free tool tip against a stop disposed before the tool holder and adjusted to the desired length dimension. However in the case of shrink chucks which can be thermally widened safety measures must additionally be taken if injuries are to be prevented.

From a second viewpoint an object of the invention is to provide a structurally simple tool holder which permits minimum quantity lubrication of the tool, yet which can be handled more easily than previously, in particular in conjunction with a tool length adjusting appliance.

Starting out from the tool holder already illustrated at the outset, this object is solved from the second viewpoint of the invention in that a spring is associated with the stop sleeve, which spring biases the stop sleeve relative to the holder body towards the receiving opening.

The spring automatically clamps the stop sleeve, which is telescopic relative to the tube section, against the front end of the tool shank and therefore automatically provides a sealing seat with respect to the lubricant channels possibly extending in the tool shank. On the other hand, before the tool holder exerts a clamping action, the spring attempts to push the tool shank out of the holder. This expulsion movement can be utilised for bearing contact of the tool tip against a stop, projecting in the expulsion path, of a tool length adjusting appliance without this expulsion movement having to be manually assisted. It is understood that the stop of the adjusting appliance can be brought manually into the desired position or can be placed in the desired position by means of a positioning drive against the force of the spring. However it is also possible to use, tool length adjusting appliances with a stop mandrel reaching through the stop sleeve in this configuration of the tool holder if at least one locking member which can fix the stop sleeve against the force of the spring in a substantially retracted, yet otherwise releasable position is associated with the stop sleeve. The tool shank can then be clamped in a positioned manner by means of the stop mandrel of the adjusting appliance. It is then sufficient to simply release the interlock to achieve the tight connection.

The spring which is supported at the stop sleeve may be formed as a helical spring and be supported by way of its other end directly at the holder body. The tube section can in this case be formed integrally on the holder body or be firmly connected to a component of the fluid coupling. In order to be able to interchange the components and optionally standardise them for different types of tool holders, the tube section, the stop sleeve and the spring form a separate, interchangeable construction unit. For this purpose the tube section has an annular flange at its end which is adjacent to the fluid coupling and the stop sleeve has an annular shoulder at its external surface area, the spring being clamped between the annular flange and the annular shoulder. A construction unit of this kind can be disposed directly in the through-opening of the holder body.

The construction unit is preferably fitted from the side of the fluid coupling which comprises a coupling sleeve which projects from the holder body equiaxially with the through-opening towards the side of the coupling section and is removably fastened to the holder body, at the end of which sleeve which axially faces the through-opening the annular flange is supported. The tube section can in this case be loosely supported axially by way of an annular front face at an annular face which is fixed relative to the holder body. In a simple configuration the annular front face of the tube section and the annular face which is fixed relative to the holder body are formed as plane, axially normal faces. However, as far as the coupling sleeve of the fluid coupling can be deflected slightly in a radially resilient manner, as already illustrated above, the annular front face of the tube section and the annular face which is fixed relative to the holder body are formed as concentric spherical segmental joint faces which are associated with one another in order also to prevent the formation of pockets when the coupling sleeve is deflected.

The stop sleeve is biased towards the receiving opening by the spring. In order to prevent, in a structurally simple manner, the receiving sleeve from being pushed through the receiving opening out of the tool holder, the through-opening can be formed as a stepped opening whose inside diameter decreases in at least one step towards the receiving opening and forms an annular shoulder for limiting the movement of the stop sleeve at the transition to the receiving opening, wherein the holder body has removable stop means for the tube section on the side of the through-opening which has the smaller diameter, as has been illustrated above. In this case the stop sleeve and the spring are fitted from the side of the coupling section. However the though-opening may alternatively also be formed as a stepped opening whose inside diameter increases in at least one step towards the receiving opening, wherein the holder body has stop means for the stop sleeve on the side which has the larger diameter. In this variant the stop sleeve is fitted through the receiving opening. The stop means for the stop sleeve may be subsequently inserted retaining rings or securing pins in a position of the holder body located outside of the insertion region of the tool shank. However the stop sleeve may alternatively also have a certain overdimension related to the diameter of the receiving opening, so that the stop sleeve can only be displaced in the diameter of the larger through-opening, yet passage through the receiving opening is prevented. The overdimension of the stop sleeve can be produced after the stop sleeve has been fitted through plastic deformation; however the stop sleeve can optionally also be pushed through the receiving opening while overcoming the press fit, for which purpose the receiving opening can optionally also be thermally widened. Also suitable are radially resilient locking members which cannot be overcome by the force of the spring alone.

The stop sleeve must usually be adapted to the shank diameter of the tool which is to be clamped in the case of the tool holders illustrated above. The through-opening of the holder body in the region of movement of the stop sleeve must consequently also be selected according to the tool shank diameter. However it is of advantage to standardise the other components involved in the minimum quantity lubricating system. In the case of the tool holder illustrated from the first viewpoint of the invention an advantageously standardised tool holder set is characterised in that the receiving openings of the tool holders have diameters of different sizes, while the positioning tubes of the tool holders have inside diameters and outside diameters of a standard size. With regard to a tool holder set corresponding to the second viewpoint of the invention, in which the receiving openings of the tool holders again have diameters of different sizes, the through-openings in the region of the tube sections as well as the tube sections have a standard diameter. Also of advantage in this connection is a two-part configuration of the stop sleeve in which the support face associated with the spring is provided at a first sleeve part and the stop face which is to be clamped against the tool shank is provided at a second sleeve part which is separate, yet connected to the first sleeve part in terms of operation. The first sleeve part can be configured so as to be standard for the set of tool holders, while the second sleeve part can be adapted to the changing shank diameter.

The tool holders illustrated from the second viewpoint simplify the pre-adjustment of the overall length of the tool-tool holder units in that the spring of the tool holder gives rise to an expulsion movement of the tool shank before the tool holder is tightened and this expulsion movement can be utilised for automatic abutment of the tool tip against a stop of the adjusting appliance. This idea, illustrated above in connection with a minimum quantity lubricating system, has independent inventive significance and can also be used with tool holders with other cooling or/and lubricating systems or for tool holders without coolant or lubricant passing through. An essential feature is that a stop element is disposed in an axially mobile manner in the through-opening of this tool holder, which element forms a stop face for the front end of the tool shank on the side of the receiving opening, the stop element comprising a spring which biases the stop face towards the front end of the tool shank. The stop element can be a separate element which can be displaced in the through-opening. However the stop element may also be formed directly by the end of the spring which faces the receiving opening, which spring is supported by way of its axially other end at the holder body. For example, the spring may be retained at a set screw which is screwed into a thread of the through-opening. However the arrangement proves to be particularly simple if the spring is formed as a helical compression spring which is screwed by way of some of its coils in the region of its end remote from the receiving opening into this internal thread of the through-opening.

A particularly simple configuration is achieved if the end of the helical compression spring which faces the receiving opening also at the same time forms the stop face by way of at least one coil in the region of its end. For tools with a conical shank end the helical spring end which forms the stop face is in turn widened conically towards the receiving opening, whereby the helical spring is guided at the tool shank. However the helical compression spring may also be a spring which is stepped in the axial direction and is supported by way of its diameter of the smaller section at the tool shank end, while the diameter of the larger section fixes the spring in the through-opening. Helical compression springs which taper conically over a part of their length towards the receiving opening, for example, in order to stabilise the spring deflection have also proved to be of advantage.

The invention is illustrated in detail in the following on the basis of drawings, in which:

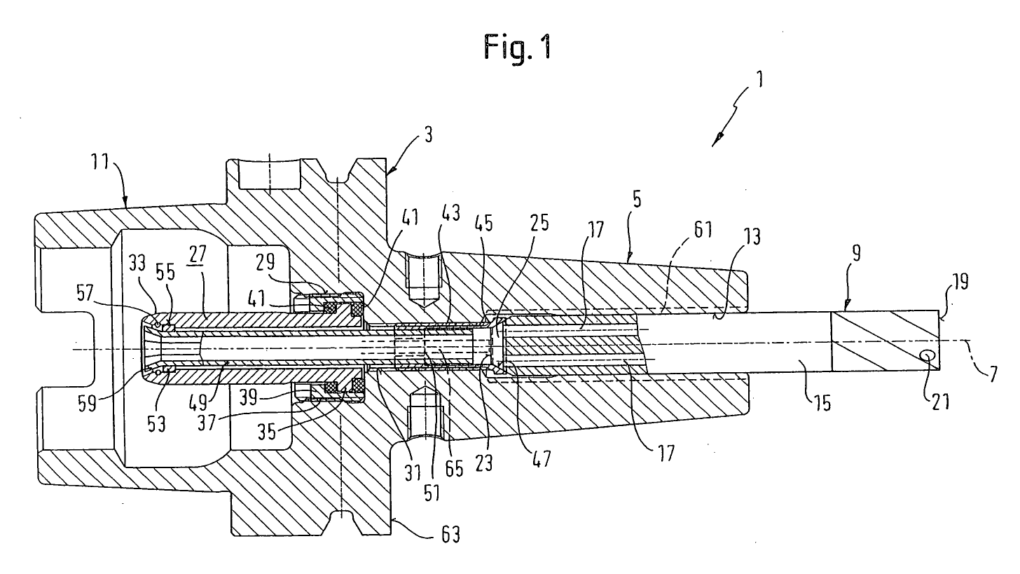

FIG. 1 is an axial longitudinal section through a tool holder of the shrink chuck type with a lubricant passage;

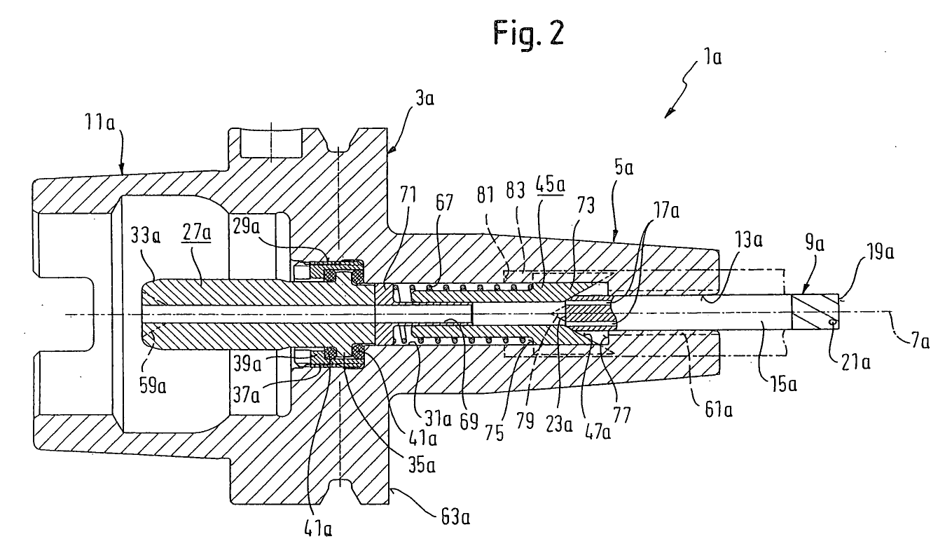

FIG. 2 is an axial longitudinal section through a first variant of the tool holder;

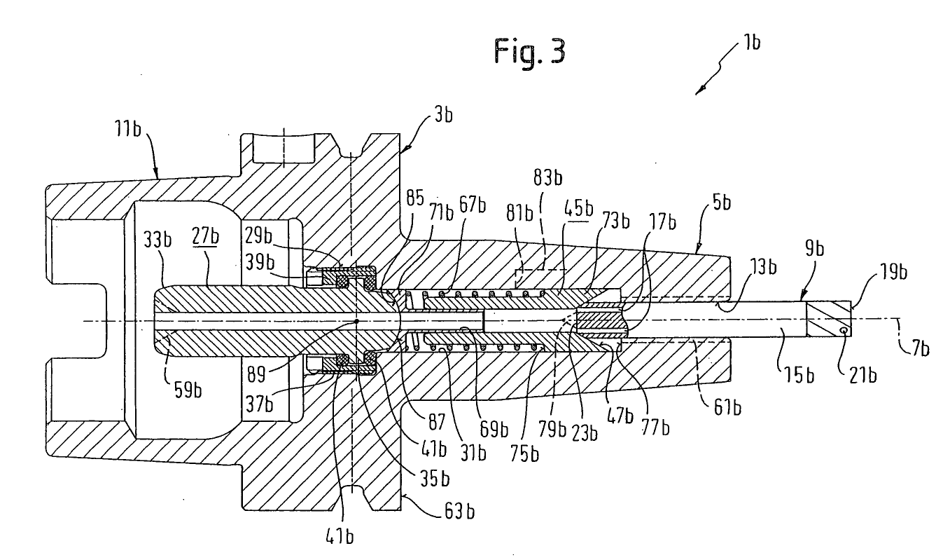

FIG. 3 is an axial longitudinal section through a second variant of the tool holder;

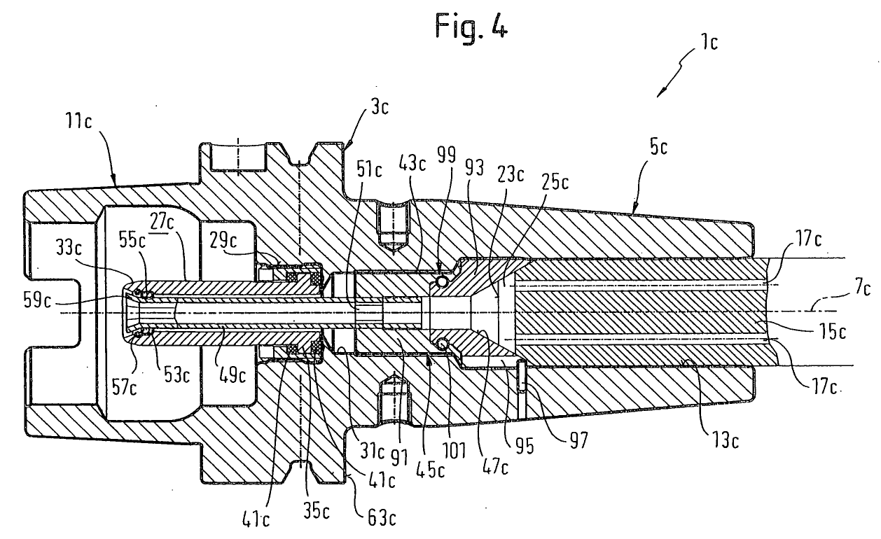

FIG. 4 is an axial longitudinal section through a third variant of the tool holder;

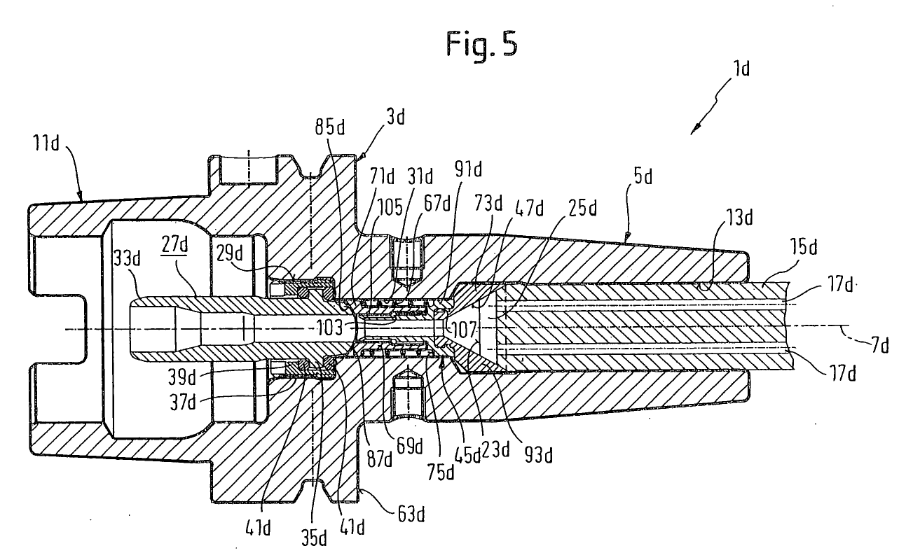

FIG. 5 is an axial longitudinal section through a fourth variant of the tool holder;

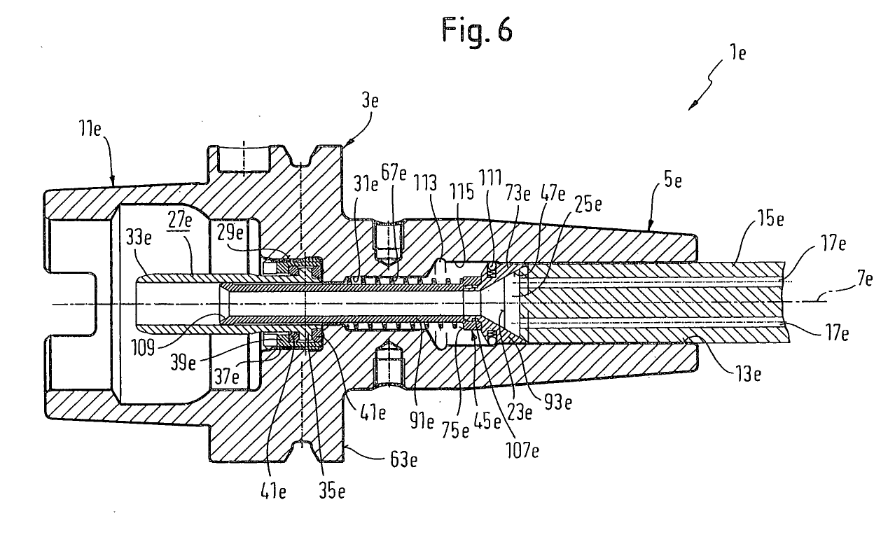

FIG. 6 is an axial longitudinal section through a fifth variant of the tool holder;

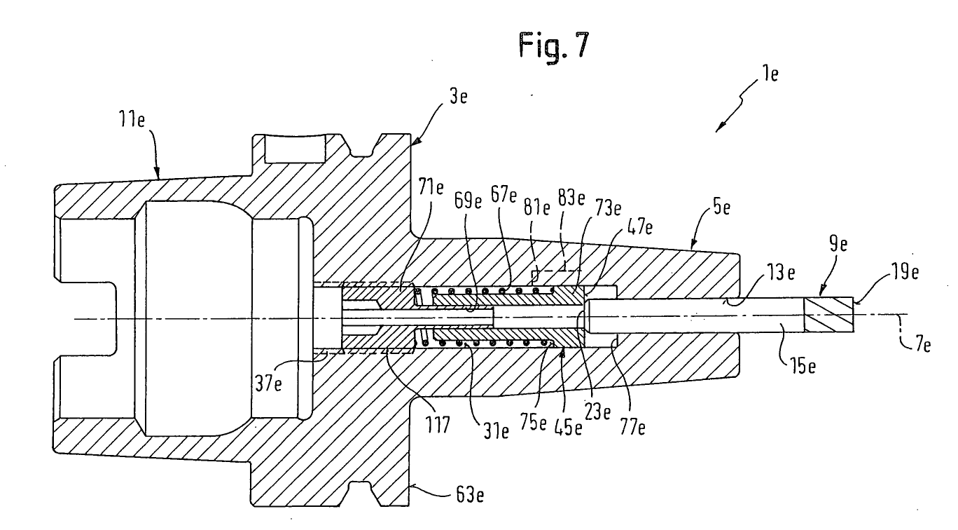

FIG. 7 is an axial longitudinal section through a tool holder of the shrink chuck type with an arrangement which facilitates the length pre-adjustment and

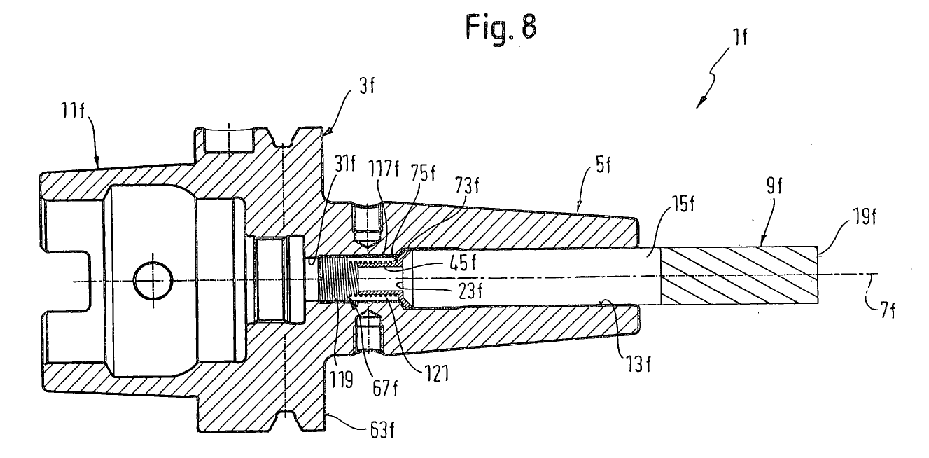

FIGS. 8 to 10 are axial longitudinal sections through variants of the tool holder from FIG. 7.

FIG. 1 shows a tool holder 1 of the shrink chuck type whose holder body 3, which as a rule is in one part, has a sleeve-shaped tool receiving section 5 for a tool 9, for example a milling cutter or drill, which is to be driven so as to rotate about an axis of rotation 7, axially at one end of the holder body 3 and a coupling section 11, here in the form of a hollow shank coupling, at the axially opposite end for the rotationally rigid coupling with a rotating drive spindle, which is not represented in detail, of a machine tool. The receiving section 5 has a receiving opening 13 which is central relative to the axis of rotation 7 and which can be widened thermally, in particular through inductive heating by means of an induction coil, so that the tool 9 can be loosely inserted by way of its shank 15 in the receiving opening 13 or removed from the latter. The shank 15 is retained in a press fit following cooling of the receiving section 5.

A plurality of axial channels 17, in this case two, extend parallel to the axis of rotation 7 in the tool 9, which channels in each case open out at 21 adjacent to the free end 19 of the tool 9 and are accessible at the axially opposite front end 23 of the shank 15 via a diametrical transverse groove 25. The channels 17 convey lubricant fluid, which is supplied to the tool holder 1 during operation from the side of the main spindle at a coupling sleeve 27, in the region of the cutting edges of the tool 9. The coupling sleeve 27 is fastened by way of one of its ends in a widening 29 of a through-opening 31, which reaches into the receiving opening 13 and is central relative to the axis of rotation 7, and can be tightly coupled at its end 33 projecting freely towards the coupling section 11 to a mating piece, which supplies the lubricating fluid, of the main spindle. For the purpose of fastening in the widening 29 the coupling sleeve 27 bears an annular collar 35 which is axially fixed between two resilient sealing rings 41 by means of a sleeve screw 39 which is screwed into an internal thread 37 of the widening 29. The free end 33 of the coupling sleeve 27 is therefore radially mobile to a slight extent in order to compensate for alignment tolerances.

Axially adjacent to the receiving opening 13 the through opening 31 has an internal thread 43 into which a stop sleeve 45 provided with an external thread is screwed. The end of the stop sleeve 45 which faces the end 23, frustoconical at the circumference, of the shank 15 forms a hollow conical stop face 47 which, when abutting against the end 23, closes the transverse groove 25.

The stop sleeve 45 is coupled in a telescopic, yet rotationally rigid manner to a positioning tube 49, which in turn is retained in the coupling sleeve 27 in a rotatable, yet axially fixed manner. The positioning tube 49 has a uniformly polygonal cross section substantially over its entire axial length at both at its internal surface area and its external surface area and projects into the stop sleeve 45 in an axially displaceable manner. A complementary polygonal circumferential surface is formed at the internal surface area of the stop sleeve 45, as indicated at 51, which surface is positively coupled to the polygonal outside of the positioning tube 49.

Adjacent to the free end 33 of the coupling sleeve 27 the positioning tube 49 bears an annular collar 53 with a circular outer circumference which is retained in a recess 55 of the coupling sleeve 27 by means of a retaining ring in a rotatable, yet axially fixed manner. The end region 59 of the positioning tube 49 which is adjacent to the end 33 is widened conically towards the free end.

The internal surface area of the positioning tube 49 likewise has a polygonal cross section, in this case a hexagonal cross section, and therefore forms tool engagement areas for a positioning tool, by means of which the stop screw 45 can be screwed by way of its internal cone 47 with a sealing action against the end 23 of the shank 15.

The tool holder 1 enables the tool 9 to be lubricated with a lubricant mist in a minimum quantity lubricating system (MQL system). The lubricant mist is blown in at the end 59 of the positioning tube 49 and flows substantially deflection-free and turbulence-free via the channels 17 to the outlet openings 21 of the tool 9. As the lubricant mist has a tendency to deposit the lubricant when there is turbulence at edges and abrupt diametrical changes, provision is made—in the form of channels extending axially as invariably as possible and optionally conical transitions, as represented at 59—for the cutting edges of the tool 9 to be continuously and uniformly lubricated. Since, moreover, the positioning tube 49 engages in the stop sleeve 45, the annular gap remaining between the positioning tube 49 and the internal surface area of the stop sleeve 45 on account of tolerances is only open in the direction of flow, so that any deposited lubricant, such as, for example, oil or similar, cannot settle in the annular gap.

Two lubricant channels 17 are directly provided in the tool 9 in the represented embodiment. It is understood that a single, then preferably central channel may optionally also be provided. A plurality of axially extending grooves 61 may alternatively also be provided at the circumference of the receiving opening 13 of the receiving section 5, which grooves form, together with the external surface area of the shank 15, lubricant channels which convey the lubricant mist outwards. It is understood that in this case the stop sleeve 45 must have radial openings in the region of its end which is on the tool side.

The tool holder 1 can be adjusted in a tool length pre-adjusting appliance to a certain length of the tool-tool holder unit between the end 19 of the tool 9 and a reference face 63 of the tool holder. For pre-adjusting devices which predetermine the depth of insertion of the shank 15 in the receiving opening 13 by means of a stop mandrel, the positioning tube 49 and the stop sleeve 45 form a through-channel for the stop mandrel, which is indicated at 65, abuts against the end 23 of the shank 15 and in this respect establishes the predetermined depth of insertion. It is understood that the stop sleeve 45, which can be moved axially by means of the positioning tube 49, can take over the function of the stop mandrel 65. It is in this respect of advantage that the positioning tube 49 is fixed relative to the holder body 3 and the tool engagement areas therefore occupy an invariably axial position. This facilitates handling and optionally automation of the pre-adjusting operation.

As a rule tool holders for different tool shank diameters differ solely by the dimensions of their receiving sections. It is therefore expedient, in order to achieve standardisation, for a set of tool holders of a similar type, yet different tool shank diameter, to give the coupling sleeve 27 and the positioning tube 49 standard diameters and only to adapt the stop sleeve 45 to the changing shank diameter.

Variants of the tool holder illustrated above are described in the following. Equally acting components are marked with the reference numbers of components illustrated above and given a letter for distinction. The entire description is discussed in order to illustrate the structure and the mode of operation. It is understood that components and variants which are described on the basis of the illustrated tool holders can also be used for the other illustrated tool holders.

In the case of the tool holder 1 of FIG. 1 the stop sleeve 45 is brought through a manual or motorised rotary drive of the positioning tube 49 into bearing contact, optionally of the sealing kind, with the front end 23 of the tool 9. FIG. 2 shows a tool holder 1a in which the stop face 47a, which widens conically towards the tool 9a, of the stop sleeve 45a is automatically pressed by means of a helical compression spring 67 against the front end 23a of the tool shank 15a. The stop sleeve 45a is seated in an axially displaceable manner in the through-opening 31a, which reaches up to the receiving opening 13a of the receiving section 5a, and encloses a socket 69, which projects telescopically from the side of the coupling section 11a into the stop sleeve 45a. The socket 69 bears an annular flange 71 which is guided radially in the through-opening 31a and at which the helical compression spring 67 is axially supported by way of one of its ends. The helical compression spring 67 encloses the stop sleeve 45a and is supported by way of its other end at an annular shoulder 75 which is formed by a head 73 guided radially in the through-opening 31a and forming the stop face 47a.

The socket 69 with its annular flange 71, the helical compression spring 67 and the stop sleeve 45a form a construction unit which is fitted as such so as to be interchangeable in the through-opening 31a. For this purpose the through-opening 31a is formed as a blind-end opening which narrows on the side of the receiving section 5a at an annular shoulder 77 which defines the expulsion path of the stop sleeve 45a. The annular flange 71 is supported at the coupling sleeve 27a, which likewise projects into the through-opening 31a, on the side of the coupling section 11a. As has already been explained on the basis of FIG. 1, the coupling sleeve 27a is removably fastened to the holder body 3a and can move slightly radially by way of its free end 33a once the annular flange 71 is supported loosely at the coupling sleeve 27a.

The tool holder 1a is also suitable for a minimum quantity lubricating system. The lubricating mist is supplied to the coupling sleeve 27a at its free end 33a or optionally produced in the coupling sleeve 27a, in which case the coupling sleeve can be provided with a funnel-shaped feed cone 59a in order to prevent unwanted turbulence. As the socket 69 projects into the sleeve extension 45a in the direction of fluid flow, it does not form a pocket which can be charged in the direction of flow and in which lubricant can accumulate. The inside diameter of the stop sleeve 45a is larger than the external spacing of the two channels 17a of the tool 9a, so that there is no need for a transverse groove as represented in FIG. 1 at 25. However the front end 23a of the shank 15a can alternatively be provided with a central flow guide cone 79 radially inside the arrangement circuit of the channels 17a. It is understood that the tool holder 1a may also be provided at the internal surface area of its receiving opening 13a with the lubricant grooves 61a already illustrated on the basis of FIG. 1 in order that tools without their own lubricant channels can also be used.

The stop sleeve 45a which is pressed by the helical compression spring 67 against the shank 15a fulfils a dual purpose. As far as is necessary, it serves to seal the lubricant path leading through the coupling sleeve 27a, the socket 69 and the stop sleeve 45a to the channels 17a of the tool 9a relative to the front face 23a of the shank 15a and, in conjunction with a tool length adjusting appliance, facilitates the length adjustment of the tool-tool holder unit. The adjusting appliance has a measurement stop which can be adjusted to a desired linear distance between itself and the reference face 63a of the tool holder 1a. In the case of a thermally widened receiving section 5a the compression spring 67 pushes the end 19a of the tool 9a against this pre-adjusted stop without the need for manual assistance. The measurement stop can in this case be moved into the desired distance position manually or by means of a positioning drive while overcoming the force of the helical compression spring 67.

It is also expedient in the case of the tool holder 1a of FIG. 2 to standardise the lubricant supply components and for this purpose to configure at least the tube section 69 with its annular flange 71 as well as optionally the coupling sleeve 27a with a standard diameter and otherwise just to adapt the head 73 of the stop sleeve 45a to a changing diameter of the tool shank 15a. As in this case the diameter of the tool shank 15a may possibly also be larger than the diameter of the annular flange 71a, the through-opening 31a may also be formed as a stepped opening which widens towards the receiving section 5a at an annular shoulder 81. The head 73 may in this respect be guided in a displaceable manner in a widening 83, the diameter of which is slightly larger than the diameter of the receiving opening 13a in the region of its clamping faces retaining the shank 15a. The head 73 is in this case pressed axially into the widening 83, with possible thermal widening of the receiving section 5a, in spite of a slight overdimension. It is understood that other expulsion inhibitions may also be provided, for example stops in the form of subsequently fitted bars engaging axially in the expulsion path of the stop sleeve or plastically deformable material regions.

In the case of the tool holder 1a of FIG. 2 the annular flange 71 and the coupling sleeve 27a abut against one another at axially normal, plane front faces. FIG. 3 shows a tool holder 1b which only differs from the tool holder 1a in that the annular flange 71b and the coupling sleeve 27b abut against one another at spherical segmental faces 85 and 87, respectively, the centre 89 of which lies in the centre plane of the annular collar 35b of the coupling sleeve 27b. Therefore the pivotal movement of the coupling sleeve 27b, which is possible on account of the resilient mounting of the coupling sleeve 27b, does not result in a gap between the faces, abutting against one another, of the annular flange 71b and the coupling sleeve 27b, even upon deflection of the coupling sleeve 27b.

FIG. 4 shows a variant of the tool holder which is illustrated on the basis of FIG. 1 and which only differs from this tool holder by the configuration of its stop sleeve 45c. The stop sleeve 45c is split axially and has a first sleeve part 91 which bears the external thread of the sleeve part 45c and is screwed by way of this into the internal thread 43c of the through-opening 31c. The first sleeve part 91 is in addition coupled in a rotationally rigid, yet axially mobile manner to the positioning tube 49c via the positive-locking area 51c. The second sleeve part 93, which is adjacent to the receiving opening 13c, projects into the receiving opening 13c and forms the conical stop face 47c, by way of which the stop sleeve 45c abuts with a sealing action against the conical front end 23c of the tool shank 15c. The second sleeve part 93 is secured against twisting by a securing pin 97 engaging in an axial slot 95 at the outer circumference of the second sleeve part 93, but can move axially together with the first sleeve part 91. A friction-reducing pivot bearing 99 with a plurality of rolling bodies, here in the form of balls 101, which are distributed at the circumference, is disposed between the two sleeve parts, via which bearing the two sleeve parts 91, 93 axially support one another. The pivot bearing 99 reduces the torques which are to be applied via the positioning tube 49c when the stop face 47c abuts with a sealing action. It is understood that a sliding contact bearing may also be provided instead of a rolling contact bearing.

FIG. 5 shows a tool holder 1d which is similar to the tool holder 1b from FIG. 3. The tool holder 1d primarily differs from the tool holder 1b in that, similarly to the tool holder 1c from FIG. 4, its stop face 45d is formed in two parts for the purpose of easier standardisation. The first sleeve part 91d forms the annular shoulder 75b, at which the helical compression spring 67d is supported by way of one of its ends, while the second sleeve part 93d forms the stop face 47d, by way of which the stop sleeve 45d seals the front end 23d of the tool shank 15d. Unlike in the embodiment of FIG. 3, the first sleeve part 91d engages telescopically in the socket 69d and is limited here to a predetermined extent of the axial telescopic movement by a locking ring 103. The first sleeve part 91d is provided with a feed cone 105 for the lubricating fluid at its end which faces the coupling sleeve 27d. Here too the tube section 69d has an annular flange 71d which is supported via spherical segmental guide faces 85d and 87d, respectively, at the coupling sleeve 27d. The two sleeve parts 91d and 93d are connected together firmly, yet releasably in terms of operation, in the represented embodiment via a bayonet connection 107.

It is understood that in the case of the configurations illustrated above the tube section, as represented in FIG. 5 at 69d, may optionally also be integrally connected to the coupling sleeve 27d if the radial mobility thereof is sufficiently low or the telescopic connection between the socket and the stop sleeve permits sufficient clearance of motion between the socket and the stop sleeve.

FIG. 6 shows a further embodiment of a tool holder 1e which primarily differs from the tool holders of FIGS. 2 to 5 illustrated above in that the stop sleeve 45e projects directly, yet telescopically into the coupling sleeve 27e of the fluid coupling. Similarly to the variant of FIG. 5, in this configuration as well the stop sleeve 45a is formed in two parts and projects by way of its first sleeve part 91e, which forms the support shoulder 75e for the helical compression spring 67e, into the coupling sleeve 27e, where it forms a conical feed funnel 109 for the lubricating fluid at its axial end. The second sleeve part 93e is again connected firmly in terms of operation to the first sleeve part 91e, for example via a bayonet coupling 107e.

In order to be able to pre-adjust the tool holder 1e, optionally also with the aid of a tool length pre-adjusting appliance, which positions the tool shank 15e by means of a stop mandrel introduced from the side of the coupling section 11e through the coupling sleeve 27e and the stop sleeve 45e, radially resilient locking members 111, here in the form of radially resilient balls, which are biased towards the receiving opening 13e, at the second sleeve part 93e are associated to the stop sleeve 45e. When the stop sleeve 45e is in the substantially completely retracted position an annular groove 113 at the inner circumference of the receiving opening 13e is associated with the locking members 111. The arrangement is such that the stop sleeve 45e can be arrested against the expulsion force of the helical compression spring 67e in the retracted position. The tool shank 15e can then be clamped in an axially positioned manner by means of the stop mandrel when the stop sleeve 45e is in the retracted position. The interlock is afterwards released by exerting an axial force on the stop sleeve 45e, whereupon the helical compression spring 67e places the stop sleeve 45e with a sealing action against the shank end 23e. A suitable tool can be introduced through the coupling sleeve 27e in order to release the locking connection. The tool may optionally be a component part of the fluid coupling on the spindle side, so that the stop sleeve 45e is also at the same time placed against the tool shank 15e when the fluid connection is coupled.

The locking members 111 may also be used as an expulsion lock for the stop sleeve 45e. The receiving opening 13e widens towards the through-opening 31e in a region 115, while forming a shoulder which prevents the expulsion of the stop sleeve 45e.

The tool holder 1a from FIG. 2 on the one hand enables improved minimum quantity lubrication of the tool to be achieved and on the other simplifies handling when pre-adjusting the length of the tool-tool holder unit. FIG. 7 shows a variant of the tool holder from FIG. 2 in which the components 17, 21, 25, 27 to 35, 39, 41, 59, 61 and 79 required for the minimum quantity lubrication are not included and only the components which can be used for the pre-adjustment are provided. The tool holder 1e in FIG. 7 therefore only comprises the stop sleeve 45e, which abuts by way of its front face 47e against the front end 23e of the tool shank 15e, the helical compression spring 67e and the socket 69e, which is screwed by way of its annular flange 71e, which here bears an external thread 117, into the internal thread 37e of the through-opening 31e. In this case the socket 69e serves solely to guide the stop sleeve 45e and can optionally be omitted. The stop sleeve 45e can also be omitted if the helical compression spring 67e is appropriately configured, if the end coil of the helical compression spring 67e is configured such that it can abut directly against the front end 23e of the tool shank 15e. The components 45e, 67e, 69e and 71e also form an interchangeable construction unit in the configuration of FIG. 7, in which case a head 73e may also optionally be adapted to different diameters of the tool shank 45e here, while the annular flange 71e may have a standard form with different shank diameters, as has already been explained in connection with FIG. 2. The through-opening 31e of the tool holder 1e can again be formed as a stepped opening which tapers or widens at a shoulder 77e or a shoulder 81e. The description of FIG. 2 and the complementary illustrations relating to FIG. 1 are also to be referred to in this connection.

FIGS. 8 to 10 show variants of the tool holder 1e from FIG. 7 with a particularly simple design. The tool holder 1f from FIG. 8 comprises a helical compression spring 67f which is screwed by way of its end region 119 axially facing the coupling section 11f directly into the internal thread 117f of the through-opening 31f. The helical compression spring 69f is formed as a cylindrical, yet stepped spring and has on its side which axially faces the receiving opening 13f a section 121 which is reduced in diameter and guided at a stop sleeve 45f. The stop sleeve 45f widens towards the receiving opening 13f to a head 123 which forms the stop face 47f for the front end 23f of the tool shank 15f and forms the support face 45f supporting the front end of the helical compression spring 67f on its side which is remote from the stop face 47f.

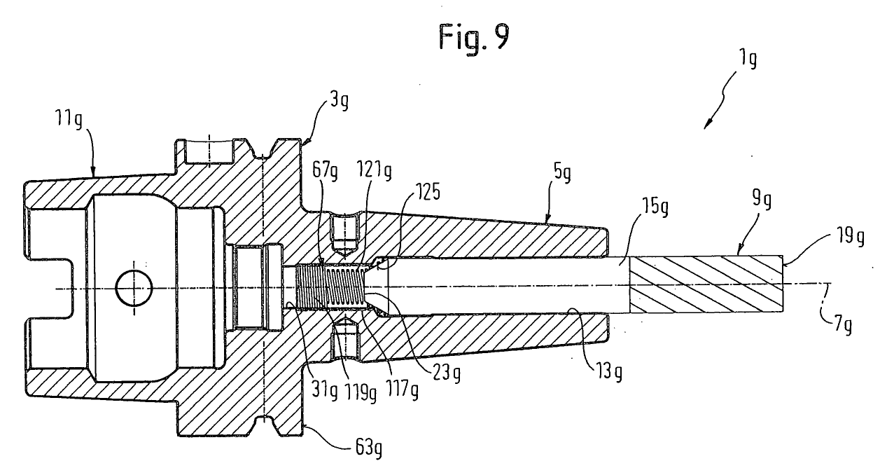

FIG. 9 shows a tool holder 1g which substantially only differs from the tool holder 1f of FIG. 9 in that, instead of the support sleeve 45f, a plurality of coils of the helical compression spring 67g are widened to form a guide cone 125 in the region of the end of the helical compression spring 67g which faces the receiving opening 13g. Otherwise the helical compression spring 67g is also formed here as a stepped cylindrical spring which is screwed by way of its end region 119g facing the coupling section 11g directly into the internal thread 117g of the through-opening 31g.

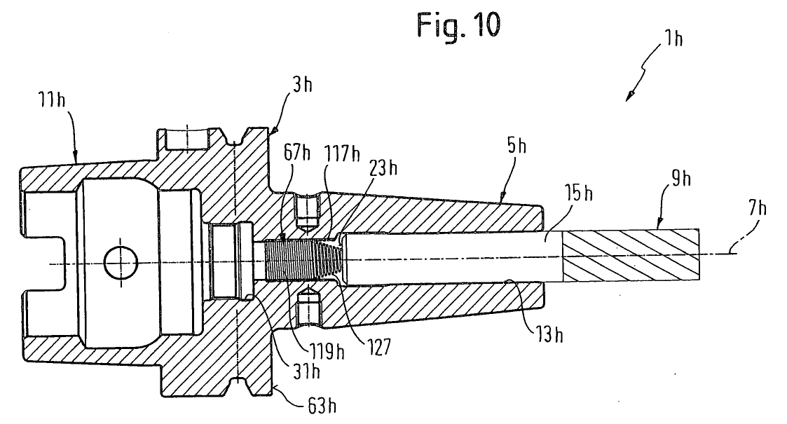

FIG. 10 shows a tool holder 1h which substantially only differs from the tool holder 1g of FIG. 9 in that the helical compression spring 67h screwed by way of its section 119h into the internal thread 117h tapers like a conical spring towards the receiving opening 13h in its axially free and therefore resilient section 121h. The conical shape increases the guidance stability of the helical compression spring 67h. Similarly to the spring 67f from FIG. 5, the spring 67h also abuts directly against the front end 23h of the tool shank 15h.

1. Tool holder for a tool which is to be driven so as to rotate about an axis of rotation and the shank of which comprises at least one channel extending along the axis of rotation for a cooling or/and lubricating fluid or defines the channel cross section together with the tool holder, comprising
a) a holder body which has a tool receiving section with a receiving opening, which is central relative to the axis of rotation, for receiving the tool shank in a rotationally rigid, yet releasable manner, a coupling section for the rotationally rigid, yet releasable connection with a drive spindle driven so as to rotate and a through-opening which is equiaxial with the receiving opening, passes into this and is open towards the side of the coupling section,
b) a stop sleeve which is disposed so as to be axially mobile in the through-opening and forms a stop face for the front end of the tool shank on the side of the receiving opening and,
c) a fluid coupling, which is central relative to the axis of rotation, on the side of the coupling section for supplying the cooling or/and lubricating fluid, wherein the stop sleeve has an external thread and is seated in an axially screwable manner in an internal thread of the through-opening, that a substantially closed-wall positioning tube, which is axially accessible from the side of the coupling section in the fluid coupling and is coaxial with the axis of rotation, is disposed in the through-opening so as to be rotatable, yet axially fixed relative to the holder, and that the stop sleeve is coupled in a rotationally rigid, yet axially mobile manner to the positioning tube and axially overlaps in a telescopic manner with the end of the positioning tube which faces the receiving opening.

2. Tool holder according to claim 1, wherein the fluid coupling comprises a coupling sleeve which projects from the holder body equiaxially with the through-opening towards the side of the coupling section, and wherein the positioning tube is axially fixed to the coupling sleeve.

3. Tool holder according to claim 2, wherein the positioning tube has, in the region of its end which is remote from the stop sleeve, an annular collar which is axially fixed in a rotatable manner in the coupling sleeve.

4. Tool holder according to claim 1, wherein the positioning tube ends at its end remote from the stop sleeve at an axial distance from the free end of the coupling sleeve or/and widens in a frustoconical manner at its inner circumference towards the free end of the coupling sleeve.

5. Tool holder according to claim 1, wherein the positioning tube has a tool application area for an adjusting rotary tool, in particular in the form of an inner polygonal cross-sectional area, in the region of its end which is remote from the stop sleeve.

6. Tool holder according to claim 1, wherein the inside of the stop sleeve and the outside of the positioning tube have positive-locking areas, in particular polygonal cross-sectional areas, which are associated with one another.

7. Tool holder according to claim 1, wherein the positioning tube has a tube wall with a polygonal cross section, in particular a hexagonal cross section, substantially over its entire length.

8. Tool holder according to claim 1, wherein the inside of the stop sleeve forms a cone which widens towards the receiving opening on the side of the receiving opening.

9. Tool holder according to claim 1, wherein the fluid coupling, the positioning tube and the stop sleeve form a receiving channel, which is continuous from the side of the coupling section to the receiving opening and is coaxial with the axis of rotation, for an axially adjustable stop mandrel (65) of a tool length adjusting appliance.

10. Tool holder according to claim 1, wherein the stop sleeve is split in the axial direction, wherein a first sleeve part has the external thread and is connected in a rotationally rigid, yet axially mobile manner to the positioning tube and a second sleeve part forms the stop face and is axially supported equiaxially and in a rotatable manner at the first sleeve part.

11. Tool holder according to claim 10, wherein the second sleeve part is guided in a rotationally rigid, yet axially mobile manner at the holder body.

12. Tool holder according to claim 10, wherein the second sleeve part is mounted at the first sleeve part via a friction-reducing pivot bearing, in particular a rolling body bearing.

13. Tool holder according to claim 1, wherein the stop sleeve externally encloses the positioning tube.

14. Tool holder for a tool which can be driven so as to rotate about an axis of rotation and the shank of which comprises at least one channel extending along the axis of rotation for a cooling or/and lubricating fluid or defines the channel cross section together with the tool holder, comprising:
a) a holder body which has a tool receiving section with a receiving opening, which is central relative to the axis of rotation for receiving the tool shank in a rotationally rigid, yet releasable manner, a coupling section for the rotationally rigid, yet releasable connection with a drive spindle driven so as to rotate and a through-opening which is equiaxial with the receiving opening, passes into this and is open towards the side of the coupling section;
b) a stop sleeve which is disposed so as to be axially mobile in the through-opening and forms a stop face for the front end of the tool shank on the side of the receiving opening; and
c) a fluid coupling, which is central relative to the axis of rotation, on the side of the coupling section for supplying the cooling or/and lubricating fluid, wherein a spring is associated with the stop sleeve, which spring biases the stop sleeve relative to the holder body towards the receiving opening.

15. Tool holder according to claim 14, wherein the fluid coupling is connected to the stop sleeve via a tube section which is comprised in the through-opening.

16. Tool holder according to claim 15, wherein the tube section and the stop sleeve axially overlap in a telescopic manner.

17. Tool holder according to claim 16, wherein the tube section has an annular flange at its end which is adjacent to the fluid coupling and the stop sleeve has an annular shoulder at its external surface area, and that the spring is clamped between the annular flange and the annular shoulder.

18. Tool holder according to claim 17, wherein the stop sleeve and the tube section have travel limiting stops which are associated with one another and limit the expansion movement of the stop sleeve relative to the tube section.

19. Tool holder according to claim 15, wherein the tube section is loosely supported axially by way of an annular front face at an annular face which is fixed relative to the holder body.

20. Tool holder according to claim 19, wherein the fluid coupling comprises a coupling sleeve which projects from the holder body equiaxially with the through-opening towards the side of the coupling section and is removably fastened to the holder body, at the end of which sleeve which axially faces the through-opening the annular flange is supported.

21. Tool holder according to claim 19, wherein the annular front face of the tube section and the annular face which is fixed relative to the holder body are formed as plane, axially normal faces.

22. Tool holder according to claim 19, wherein the annular front face of the tube section and the annular face which is fixed relative to the holder body are formed as concentric spherical segmental joint faces which are associated with one another.

23. Tool holder according to claim 22, wherein the coupling sleeve of the fluid coupling is fastened to the holder body such that it can deflect resiliently substantially about the centre of the joint faces.

24. Tool holder according to claim 15, wherein the fluid coupling comprises a coupling sleeve which projects from the holder body equiaxially with the through-opening towards the side of the coupling section and is removably fastened to the holder body, and the tube section is firmly connected to the coupling sleeve, in particular integrally formed thereon.

25. Tool holder according to claim 14, wherein the fluid coupling comprises a coupling sleeve which projects from the holder body equiaxially with the through-opening towards the side of the coupling section and is removably fastened to the holder body, and the stop sleeve engages axially in a telescopic manner in the coupling sleeve.

26. Tool holder according to claim 14, wherein the stop sleeve comprises two sleeve parts which are connected together in an axially fixed manner in terms of operation, and wherein the spring is axially supported at a first of the sleeve parts and the second of the sleeve parts forms the stop face.

27. Tool holder according to claim 14, wherein at least one locking member which locks the stop sleeve in at least one axial position relative to the holder body in a releasable manner yet with a retaining force which cannot be overcome by the spring alone is associated with the stop sleeve.

28. Tool holder according to claim 27, wherein the locking member locks the stop sleeve in a substantially completely retracted position or/and a substantially completely expelled position.

29. Tool holder according to claim 14, wherein the through-opening is formed as a stepped opening whose inside diameter decreases in at least one step towards the receiving opening and forms an annular shoulder for limiting the movement of the stop sleeve at the transition to the receiving opening, and that the holder body has removable stop means for the tube section on the side of the through-opening which has the smaller diameter.

30. Tool holder according to claim 14, wherein the through-opening is formed as a stepped opening whose inside diameter increases in at least one step towards the receiving opening whose inside diameter increases in at least one step towards the receiving opening, and that the holder body has stop means for the stop sleeve on the side which has the larger diameter.

31. Tool holder according to claim 14, wherein the inside of the stop sleeve forms a cone which widens towards the receiving opening on the side of the receiving opening.

32. Tool holder according to claim 14, wherein at least the fluid coupling and the stop sleeve as well as optionally the tube section form a receiving channel, which is continuous from the side of the coupling section to the receiving opening and is coaxial with the axis of rotation, for an axially adjustable stop mandrel of a tool length adjusting appliance.

33. Tool holder set comprising a plurality of tool holders according to claim 1, the receiving openings of the tool holders have diameters of different sizes, while the positioning tubes of the tool holders have inside diameters and outside diameters of a standard size.

34. Tool holder set comprising a plurality of tool holders according to claim 14, wherein the receiving openings of the tool holders have diameters of different sizes, while the through-openings of the tool holders in the region of the tube sections as well as the tube sections have a standard diameter.

35. Tool holder for a tool which can be driven so as to rotate about an axis of rotation comprising:
a) a holder body which has a tool receiving section with a receiving opening, which is central relative to the axis of rotation, for receiving the tool shank in a rotationally rigid, yet releasable manner, a coupling section for the rotationally rigid, yet releasable connection with a drive spindle driven so as to rotate and a through-opening which is equiaxial with the receiving opening, passes into this and is open towards the side of the coupling section; and
b) a stop element which is disposed so as to be axially mobile in the through-opening and forms a stop face for the front end of the tool shank on the side of the receiving opening, wherein the stop element comprises a spring which biases the stop face towards the front end of the tool shank.

36. Tool holder according to claim 35, wherein the spring is formed as a helical compression spring.

37. Tool holder according to claim 36, wherein the spring is screwed by way of some of its coils in the region of its end remote from the receiving opening into an internal thread of the through-opening

38. Tool holder according to claim 35, wherein the spring is supported at a set screw which is screwed into a thread of the through-opening.

39. Tool holder according to claim 36, wherein the coil diameter of the spring is smaller on the side of the receiving opening than on the side of the coupling section.

40. Tool holder according to claim 39, wherein the spring has a section which tapers towards the receiving opening on the side of the receiving opening.

41. Tool holder according to claim 39, wherein the spring is stepped and has two cylindrical sections with different coil diameters.

42. Tool holder according to claim 36, wherein the spring bears a head which is guided radially at the holder body and forms the stop face.

43. Tool holder according to one of claim 36, wherein the spring forms the stop face by way of at least one of its coils in the region of its end adjacent to the receiving opening.

44. Tool holder according to claim 1, wherein the tool holder is a tool holder of the shrink chuck type or hydraulic expansion chuck type.
